(19) United States
(12) Patent Application Publication
(10) Pub. No.: US 2014/0055679 A1
(43) Pub. Date: Feb. 27, 2014

(54) ELECTRONIC DEVICE AND METHOD FOR CORRECTING VIDEO GRAPHICS ARRAY SIGNALS

(71) Applicant: HON HAI PRECISION INDUSTRY CO., LTD., New Taipei (TW)

(72) Inventor: CHIH-HUANG WU, New Taipei (TW)

(73) Assignee: HON HAI PRECISION INDUSTRY CO., LTD., New Taipei (TW)

(21) Appl. No.: 13/869,331

(22) Filed: Apr. 24, 2013

(30) Foreign Application Priority Data
Aug. 24, 2012 (TW) 101130862

(51) Int. Cl. H04N 9/73

(52) U.S. Cl. CPC H04N 9/73
USPC 348/708

(57) ABSTRACT

In a method for correcting video graphics array (VGA) signals using an electronic device, a VGA signal is received from a VGA card, and parsed to obtain a red-green-blue (RGB) analog signal. The RGB analog signal is converted into an RGB digital signal, the RGB digital signal comprising an R voltage, a G voltage, and a B voltage. When the RGB digital signal is not in accordance with predetermined standard values, the method corrects the RGB digital signal, and outputs the corrected RGB digital signal.

### BACKGROUND

1. Technical Field

Embodiments of the present disclosure relate to signal processing technology, and particularly to an electronic device and method for correcting video graphics array (VGA) signals of a VGA device using the electronic device.

2. Description of Related Art

VGA is a graphics standard that supports 640×480 resolution, for example. A VGA analog interface is used for high definition video including 1080p and higher. VGA signals includes red, green, blue, Horizontal sync, and Vertical sync (RGBHV) signals. For ensuring quality of the VGA signals, a signal integrity (SI) measurement of the VGA signals needs to be implemented manually, and then the VGA signals may be corrected according to measurement results.

VGA devices have different configurations according to user demands, and each of the VGA devices has different parameters, such as resistance, capacitance, and impedance, for example. Thus, different measurement methods and signal correction methods need to be implemented to measure VGA signals of different kinds of VGA devices. It is inefficient and inaccurate to implement different measurement methods and signal correction methods manually. Therefore, an efficient method for correcting VGA signals of a VGA device is desired.

### BRIEF DESCRIPTION OF THE DRAWINGS

FIG. 1 is a block diagram of one embodiment of an electronic device including a VGA signal correction system.

FIG. 2 is a block diagram of function modules of the VGA signal correction system in the electronic device.

FIG. 3 is a flowchart of one embodiment of a method for correcting VGA signals of a VGA device using the correction system.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

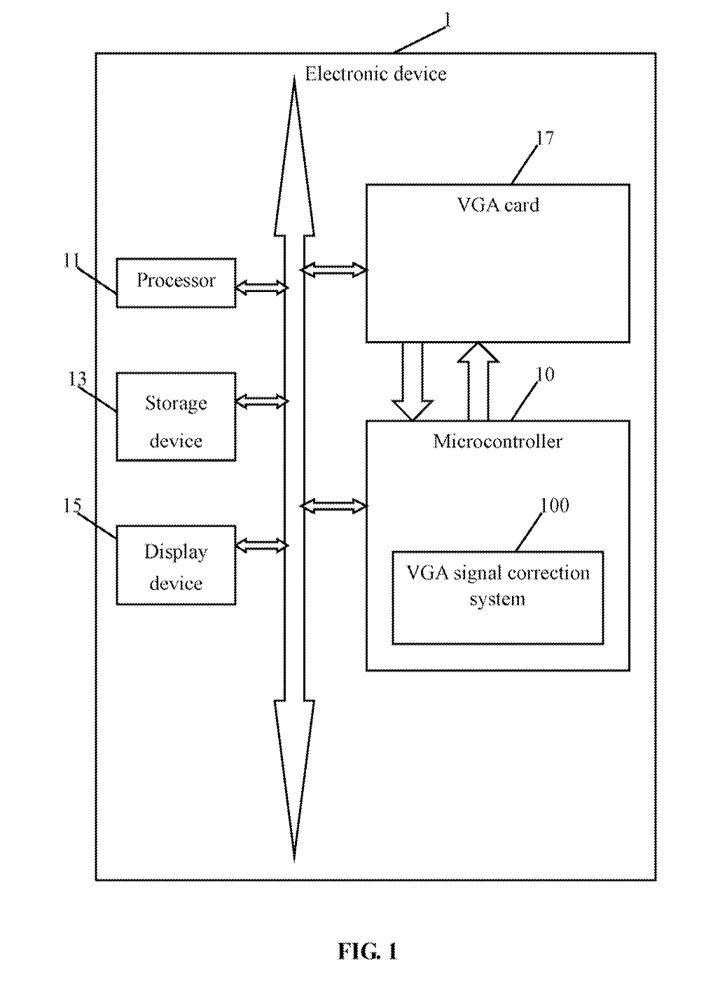

FIG. 1 is a block diagram of one embodiment of an electronic device 1 including a VGA signal correction system 100. The electronic device 1 further includes a microcontroller unit (MCU) 10, at least one processor 11, a storage device 13, a display device 15, and a VGA card 17. FIG. 1 illustrates only one example of the electronic device 1 that may include more or fewer components than illustrated, or have a different configuration of the various components.

The VGA signal correction system 100 parses VGA signals outputted by the VGA card 17 to obtain red-green-blue (RGB) signals, checks whether the RGB signals are qualified by determining whether the RGB signals are in accordance with predetermined standard values, and corrects unqualified RGB signals to ensure quality of the VGA signals. In some embodiments, the VGA signal correction system 100 may be a program embedded in the MCU 10, which may implement computerized instructions of the VGA signal correction system 100. In other embodiments, the VGA signal correction system 100 may be a program installed in the electronic device 1, thus the computerized instructions of the VGA signal correction system 100 may be implemented by the at least one processor 11, and the MCU 10 is not required.

In one embodiment, the electronic device 1 may be a mobile phone, a tablet computer, a personal digital assistant, a notebook computer, or any other device. In one embodiment, the VGA signal correction system 100 may include computerized instructions in the form of one or more programs that are executed by the at least one processor 11 and stored in the storage device 13. The storage device 13 stores one or more programs, such as operating systems, applications of the electronic device 1, and various kinds of data, such as VGA signals and RGB signals. In some embodiments, the storage device 13 may be an external storage card, such as a memory stick, a smart media card, a compact flash card, a secure digital card, or any other type of memory storage device.

The display device 15 may be a liquid crystal display (LCD) or a touch-sensitive display (a capacitive touch panel), for example. The VGA card 17 may transmit the VGA signals to other related devices, such as the display device 15, for example.

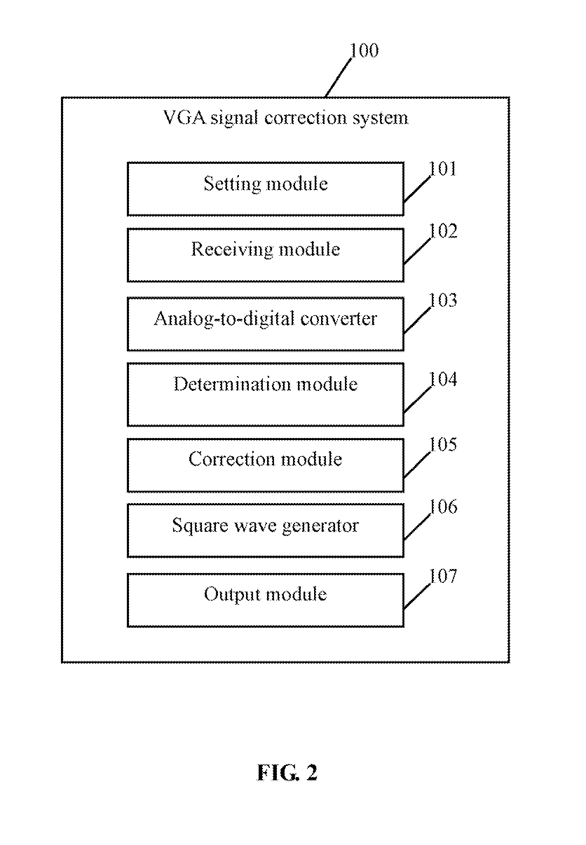

FIG. 2 is a block diagram of function modules of the VGA signal correction system 100 included in the electronic device 1. In one embodiment, the VGA signal correction system 100 may include one or more modules, for example, a setting module 101, a receiving module 102, an analog-to-digital converter (ADC) 103, a determination module 104, a correction module 105, a square wave generator 106, and an output module 107. In general, the word “module,” as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

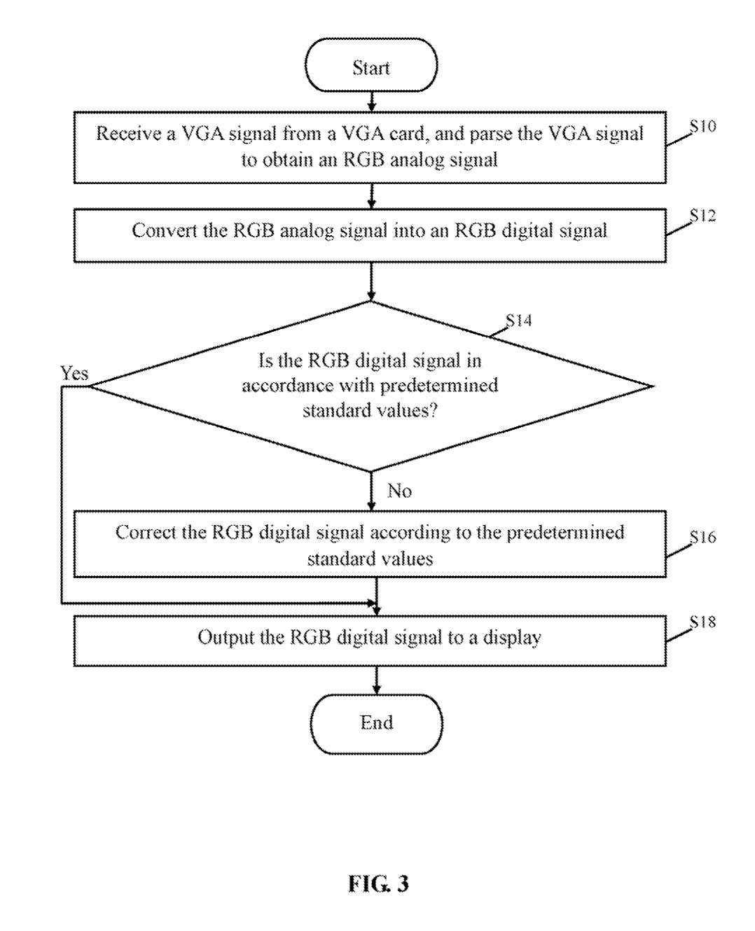

FIG. 3 is a flowchart of one embodiment of a method for correcting VGA signals of a VGA device using the VGA signal correction system 100. For example, the VGA device may be the VGA card 17. Depending on the embodiment, additional steps may be added, others removed, and the ordering of the steps may be changed.

In step S10, the receiving module 102 receives a VGA signal from the VGA card 17, and parses the VGA signal to obtain an RGB analog signal using the MCU 10 or the at least one processor 11.

In step S12, the ADC 103 converts the RGB analog signal into an RGB digital signal, the RGB digital signal includes an R signal, a G signal, and a B signal. In some embodiments, the R signal is an R voltage, the G signal is a G voltage, and the B signal is a B voltage. In other embodiments, the R voltage, the G voltage, and the B voltage also may be determined according to the RGB analog signal.

In step S14, the determination module 104 determines whether the RGB digital signal is in accordance with predetermined standard values. The predetermined standard values may be preset by the setting module 100, and include a standard R voltage, a standard G voltage, and a standard B voltage. The standard R voltage, the standard G voltage, and the standard B voltage may be same (e.g., 75 mv) or different according to measurement requirements. In other embodiments, the setting module 101 may predetermine standard ranges, such as a range of R voltages, a range of G voltages, and a range of B voltages. The determination module 104 determines whether the RGB digital signal is within the predetermined standard ranges.

If the RGB digital signal is in accordance with predetermined standard values, or is within the predetermined standard ranges, the procedure goes to step S18. If the RGB digital signal is not in accordance with predetermined standard values, or is not within the predetermined standard ranges, the procedure goes to step S16.

In other embodiments, the setting module 101 may further preset an error range of the RGB signals. When there is a difference between each of the R voltage, G voltage, and B voltage and a corresponding predetermined stand value exceeds the error range, the determination module 104 determines that the RGB digital signal is not in accordance with the predetermined standard values.

In step S16, the correction module 105 corrects the RGB digital signal according to the predetermined standard values, when the RGB digital signal is not in accordance with the predetermined standard values.

The correction module 105 determines one voltage among the RGB digital signal that is not in accordance with the predetermined standard values (hereinafter referred to as “the unqualified voltage”), and controls the unqualified voltage to be in accordance with a corresponding predetermined standard value. One or more unqualified voltages may be determined and corrected.

In some embodiments, when the unqualified voltage is less than a corresponding standard voltage, the correction module 105 determines that the unqualified voltage is low, and increases the unqualified voltage by controlling a signal driver of the electronic device 1. When the unqualified voltage (e.g., 150 mv) is larger than the corresponding standard voltage (e.g., 75 mv), the correction module 105 determines that the unqualified voltage is high, and uses a pull-down resistor to decrease the unqualified voltage.

In step S18, the output module 107 outputs the RGB digital signal that is in accordance with the predetermined standard value, to the display device 15. The outputted RGB digital signal may be a corrected RGB digital signal processed by the correction module 105, or be an original RGB digital signal converted by the ADC 103 which does not need correction. The display device 15 may display a plurality of outputted RGB digital signals.

In other embodiments not shown in FIG. 3, the square wave generator 106 may obtain a plurality of RGB digital signals from the ADC 103 during a predetermined time interval. The predetermined time interval may be preset by the setting module 101. The square wave generator 106 generates an R square wave, a G square wave, and a B square wave according to the plurality of RGB digital signals and the predetermined time interval. Each of the R square wave, the G square wave, and the B square wave includes wave parameters, such as an ascending gradient, a descending gradient, and a delay time, for example. The wave parameters may be used to determine whether the R voltage, the G voltage, and the B voltage are in accordance with the predetermined standard values.

In some embodiments, the predetermined standard values include a standard gradient, which is predetermined for verification of the ascending gradients of the R square wave, the G square wave, and the B square wave. The correction module 105 calculates the ascending gradients of the R square wave, the G square wave, and the B square wave, and determines whether the ascending gradients are in accordance with the standard gradient. When there is one ascending gradient is not in accordance with the standard gradient, the correction module 105 determines the ascending gradient, and determines a voltage corresponding to the determined ascending gradient to be the unqualified voltage.

When the determined ascending gradient exceeds the standard gradient, the correction module 105 determines that the unqualified voltage is high, and uses a pull-down resistor to decrease the unqualified voltage. When the determined ascending gradient is less than the standard gradient, the correction module 105 determines that the unqualified voltage is low, and increases the unqualified voltage by controlling the signal driver of the electronic device 1.

In other embodiments, the standard gradient may be predetermined to verify the descending gradients of the R square wave, the G square wave, and the B square wave in a manner similar to that applied to the ascending gradients.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for correcting video graphics array (VGA) signals using an electronic device, the electronic device comprising a VGA card and a microcontroller unit (MCU), the method comprising:
receiving a VGA signal from the VGA card, and parsing the VGA signal to obtain a red-green-blue (RGB) analog signal using the MCU;
converting the RGB analog signal into an RGB digital signal, the RGB digital signal comprising an R voltage, a G voltage, and a B voltage;
determining whether the RGB digital signal is in accordance with predetermined standard values, the predetermined standard values comprising a standard R voltage, a standard G voltage, and a standard B voltage; and
correcting the RGB digital signal according to the predetermined standard values, when the RGB digital signal is not in accordance with the predetermined standard values.

2. The method according to claim 1, wherein the step of determining whether the RGB digital signal is in accordance with predetermined standard values comprises:
determining that the RGB digital signal is not in accordance with the predetermined standard values, when the R voltage is not equal to the standard R voltage, the G voltage is not equal to the standard G voltage, or the B voltage is not equal to the standard B voltage.

3. The method according to claim 1, wherein the step of correcting the RGB digital signal according to the predetermined standard values comprises:
determining one voltage among the RGB digital signal that is not in accordance with the predetermined standard values; and
controlling the determined voltage to be in accordance with the predetermined standard values.

4. The method according to claim 3, further comprising:
when the determined voltage is less than a corresponding standard voltage, determining that the determined voltage is low, and increasing the determined voltage by controlling a signal driver of the electronic device; or
when the determined voltage is larger than the corresponding standard voltage, determining that the determined voltage is high, and using a pull-down resistor to decrease the determined voltage.

5. The method according to claim 1, further comprising:
obtaining a plurality of RGB digital signals during a predetermined time interval; and
generating an R square wave, a G square wave, and a B square wave using a square wave generator of the electronic device, according to the plurality of RGB digital signals.

6. The method according to claim 5, further comprising:
determining a gradient of the R square wave, the G square wave, or the B square wave when the determined gradient is not in accordance with a standard gradient, and determining a voltage corresponding to the determined gradient; and
when the determined gradient exceeds the standard gradient, determining that the determined voltage is high, and using a pull-down resistor to decrease the determined voltage; or
when the determined gradient is less than the standard gradient, determining that the determined voltage is low, and increasing the determined voltage by controlling a signal driver of the electronic device.

7. An electronic device, comprising:
a video graphics array (VGA) card;
a microcontroller unit (MCU);
a storage device;
at least one processor; and
one or more modules that are stored in the storage device and are executed by the at least one processor, the one or more modules comprising:
a receiving module that receives a VGA signal from the VGA card, and parses the VGA signal to obtain a red-green-blue (RGB) analog signal using the MCU;
an analog-to-digital converter that converts the RGB analog signal into an RGB digital signal, the RGB digital signal comprising an R voltage, a G voltage, and a B voltage;
a determination module that determines whether the RGB digital signal is in accordance with predetermined standard values, the predetermined standard values comprising a standard R voltage, a standard G voltage, and a standard B voltage; and
a correction module that corrects the RGB digital signal according to the predetermined standard values, when the RGB digital signal is not in accordance with the predetermined standard values.

8. The electronic device according to claim 7, wherein the determination module determines that the RGB digital signal is not in accordance with the predetermined standard values when the R voltage is not equal to the standard R voltage, the G voltage is not equal to the standard G voltage, or the B voltage is not equal to the standard B voltage.

9. The electronic device according to claim 7, wherein the correction module determines one voltage among the RGB digital signal that is not in accordance with the predetermined standard values, and controls the determined voltage to be in accordance with the predetermined standard values.

10. The electronic device according to claim 9, wherein the correction module controls the determined voltage by:
determining that the determined voltage is low and increasing the determined voltage by controlling a signal driver of the electronic device, when the determined voltage is less than a corresponding standard voltage; or
determining that the determined voltage is high and using a pull-down resistor to decrease the determined voltage, when the determined voltage is larger than the corresponding standard voltage.

11. The electronic device according to claim 7, wherein the one or more modules further comprise a square wave generator that obtains a plurality of RGB digital signals during a predetermined time interval, and generates an R square wave, a G square wave, and a B square wave according to the plurality of RGB digital signals.

12. The electronic device according to claim 11, wherein the correction module further:
determines a gradient of the R square wave, the G square wave, or the B square wave when the determined gradient is not in accordance with a standard gradient, and determining a voltage corresponding to the determined gradient; and
determines that the determined voltage is high and uses a pull-down resistor to decrease the determined voltage, when the determined gradient exceeds the standard gradient; or
determines that the determined voltage is low and increases the determined voltage by controlling a signal driver of the electronic device, when the determined gradient is less than the standard gradient.

13. A non-transitory storage medium having stored thereon instructions that, when executed by a processor of an electronic device, causes the electronic device to perform a method for correcting video graphics array (VGA) signals using an electronic device, the electronic device comprising a VGA card and a microcontroller unit (MCU), the method comprising:
receiving a VGA signal from the VGA card, and parsing the VGA signal to obtain a red-green-blue (RGB) analog signal using the MCU;
converting the RGB analog signal into an RGB digital signal, the RGB digital signal comprising an R voltage, a G voltage, and a B voltage;
determining whether the RGB digital signal is in accordance with predetermined standard values, the predetermined standard values comprising a standard R voltage, a standard G voltage, and a standard B voltage; and
correcting the RGB digital signal according to the predetermined standard values, when the RGB digital signal is not in accordance with the predetermined standard values.

14. The non-transitory storage medium according to claim 13, wherein the step of determining whether the RGB digital signal is in accordance with predetermined standard values comprises:
determining that the RGB digital signal is not in accordance with the predetermined standard values, when the R voltage is not equal to the standard R voltage, the G voltage is not equal to the standard G voltage, or the B voltage is not equal to the standard B voltage.

15. The non-transitory storage medium according to claim 13, wherein the step of correcting the RGB digital signal according to the predetermined standard values comprises:
determining one voltage among the RGB digital signal that is not in accordance with the predetermined standard values; and
controlling the determined voltage to be in accordance with the predetermined standard values.

16. The non-transitory storage medium according to claim 15, wherein the method further comprises:
when the determined voltage is less than a corresponding standard voltage, determining that the determined voltage is low, and increasing the determined voltage by controlling a signal driver of the electronic device; or
when the determined voltage is larger than the corresponding standard voltage, determining that the determined voltage is high, and using a pull-down resistor to decrease the determined voltage.

17. The non-transitory storage medium according to claim 13, wherein the method further comprises:
obtaining a plurality of RGB digital signals during a predetermined time interval; and
generating an R square wave, a G square wave, and a B square wave using a square wave generator of the electronic device, according to the plurality of RGB digital signals.

18. The non-transitory storage medium according to claim 13, wherein the method further comprises:
determining a gradient of the R square wave, the G square wave, or the B square wave when the determined gradient is not in accordance with a standard gradient, and determining a voltage corresponding to the determined gradient; and
when the determined gradient exceeds the standard gradient, determining that the determined voltage is high, and using a pull-down resistor to decrease the determined voltage; or
when the determined gradient is less than the standard gradient, determining that the determined voltage is low, and increasing the determined voltage by controlling a signal driver of the electronic device.
